(19) United States
(12) Patent Application Publication
(10) Pub. No.: US 2003/0236856 A1
(43) Pub. Date: Dec. 25, 2003

(54) Method and system for information enrichment using distributed computer systems

(75) Inventors: Colin L. Bird, Fair Oak (GB); Andrew J. Stanford-Clark, Chale (GB)

Correspondence Address: Jeanine S. Ray-Yarletts, IBM Corp. IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/235,313

(22) Filed: Sep. 5, 2002

(30) Foreign Application Priority Data
Jun. 1, 2002 (GB) 0212820.5

(51) Int. Cl. G06F 15/16

(52) U.S. Cl. 709/217

(57) ABSTRACT

In a system having a plurality of sources of information (102, 103, 104, 105), each source (102, 103, 104, 105) registers as being capable of providing information in respect of at least one specific class of request. When a request for information (120) is received, it is distributed to one or more sources that are registered for that class of request.

### FIELD OF THE INVENTION

This invention relates to the field of information retrieval and in particular to information enrichment using distributed computer systems.

### BACKGROUND OF THE INVENTION

It is often the case that a user has a piece of information, such as for example an ISBN book number, and the user would like to find out more about it. The user does not know what he wants to know, or the scope of the information that might be available. He wants to know what facts are available and to have the results of his enquiry arranged in a way that enhances his understanding of the subject.

### DISCLOSURE OF THE INVENTION

According to a first aspect, the invention provides a method for information enrichment in a system having a plurality of sources of information, the method comprising: each source registering as being capable of providing information in respect of at least one specific class of request; receiving a request for information; distributing the request to one or more sources that are registered for that class of request.

According to a second aspect, the invention provides a system for information enrichment comprising: a plurality of sources of information; each source being registered as being capable of providing information in respect of at least one specific class of request; a client application; wherein a request for information from the client application is distributed to sources registered for that class of request.

According to third aspect, the invention provides a computer program product stored on a computer readable storage medium for use in a system having a plurality of sources of information, comprising computer readable program code means for performing the steps of: each source registering as being capable of providing information in respect of at least one specific class of request; receiving a request for information at one of the sources; distributing the request to one or more other sources that are registered for that class of request.

According to a fourth aspect, the invention provides a method for information enrichment in a system having a plurality of sources, each source registered as being capable of providing information in respect of at least one specific class of request, the method comprising: receiving a request for information; and distributing the request to one or more sources that are registered for that class of request.

According to a fifth aspect, the invention provides an apparatus for information enrichment in a system having a plurality of sources, each source registered as being capable of providing information in respect of at least one specific classes of request, the apparatus comprising: means for receiving a request for information; and means for distributing the request to one or more sources that are registered for that class of request.

According to a six aspect, the invention provides a computer program product stored on a computer readable storage medium for use in a system having a plurality of sources of information, comprising computer readable program code means for performing the steps of: receiving a request for information; and distributing the request to one or more sources that are registered for that class of request.

According to a seventh aspect, the invention provides a source of information for participating in information enrichment, the source comprising: means for registering with a server as being capable of providing information in respect of at least one specific class of request; means for receiving a request for information in respect of one of any registered classes; and means for responding to said request.

According to an eighth aspect, the invention provides a method for participating in information enrichment comprising the steps of: registering with a server as being capable of providing information in respect of at least one specific class of request; receiving a request for information in respect of a specific class of request; and responding to said request.

According to a ninth aspect, the invention provides a computer program product stored on a computer readable storage medium, the computer readable program code means for performing the steps of: registering with a server as being capable of providing information in respect of at least one specific class of request; receiving a request for information in respect of a specific class of request; and responding to said request.

The invention preferably provides an infrastructure to enable this kind of “information enrichment” to be performed.

In a preferred embodiment, a starting point for an enquiry by a user is an “identifier” which is a representation of the conceptual form of what it is the user wants to know about. The identifier expresses a description of the target. For the book example, then the ISBN is ideal as an identifier. Most products now have a universal product code (UPC) barcode on them—that is ideal, too. If a specific enquiry fails, a more general identifier is tried.

Further, in a preferred embodiment an information hierarchy is used to classify items into useful categories. Information classification is a difficult problem, but within specific domains, various categorisation schemes exist. For example, Dewey for books, genres for music, films, etc. Correct classification, and a suitable information hierarchy to work inside, preferably enables valuable results to be generated. Significant advantages may thus accrue from a principled design of the information space.

It is possible, to have a category for which no useful information exists. According to a preferred embodiment, there are two ways for this to emerge. First, a category may be included in the hierarchy because the information may be available in the future (for example, Martian DNA). Secondly, a question may be posed for which no match can be found. The second instance is important as “no information” is a valid outcome.

Research into information-seeking behaviour in a variety of contexts has shown that users typically formulate queries in an unstructured way, relying on “knowing what I want when I see it”. Although not the full explanation, much of this behaviour derives from simply not knowing what there is available to be discovered. The invention preferably alleviates this difficulty by enabling the user to identify and work with the part(s) of the information space of particular interest. In return, he will preferably be offered a range of possible sources from which to choose.

In a preferred embodiment a response from at least one source is processed and an amended request is then sent to one or more sources. Thus it is possible to start with a subject for which only a few (maybe only one) source is able to return information and then to use this information to pump an amended request back into the system in order to expand the information received.

One of the sources of information may have a registry function which registers the capabilities of the other sources. Alternatively, each source may register with all the other sources.

In one embodiment, the request is received at a primary source and responses from other sources are returned to the primary source.

In one embodiment responses from sources may be compiled in a data structure. This structure may be returned to the origin of the request.

The request for information and/or the responses from sources may indicate if the data is factual or subjective.

In one embodiment, the plurality of sources may include publish/subscribe messaging brokers. The plurality of sources may register their capabilities by means of subscribing to other messaging brokers.

In another embodiment, the sources may have peer to peer relationships.

In a further embodiment, the plurality of sources may use TSpaces services.

Each source may use a common information classification system and be registered as being capable of providing information in respect of at least one specific class in the common information classification system. The received request for information, in this embodiment, uses the common classification system.

The common information classification system may use topic hierarchies. Alternatively, the common information classification system may use XML.

Use of a common classification system is not essential. In one embodiment, prior to distributing the received request to one or more sources, the request is translated to a format compatible with a format used by each source to which it is sent. In one embodiment, a response is received from one or more sources and at least one response is not in a common format used for collating any received responses. Thus any such responses are translated to the common format.

### BRIEF DESCRIPTION OF THE DRAWINGS

Embodiments of the present invention will now be described, by way of examples only, with reference to the accompanying drawings in which:

FIGS. 1A to 1D are schematic diagrams of a system for information enrichment in accordance with an embodiment of the present invention;

FIG. 2 is a diagram of a data structure produced by the method for information enrichment in accordance with an embodiment of the present invention;

FIG. 3 is a flow diagram of the method in accordance with an embodiment of the present invention;

FIG. 4 is a diagrammatic representation of a message broker as known in the prior art;

FIG. 5 is a diagrammatic representation of a message broker as used in accordance with an embodiment of the present invention; and

FIG. 6 is a diagrammatic representation of a network of message brokers as used in accordance with an embodiment of the present invention.

### DESCRIPTION OF THE PREFERRED EMBODIMENTS

A client may have a particular fact or subject (for example, a food packaging barcode) and wants to find out more information relating to that fact or subject. The client does not, however, know what information is available or what kind of information he wants returned.

According to a preferred embodiment an information enrichment infrastructure is provided in which agents advertise particular knowledge specialisations (for example, one agent may specialise in decoding barcodes, another in food ingredients, another in food allergies, etc.). The agents classify their information according to a common system as part of an overall information space.

A client constructs a query according to the common classification system (for example, food/curry/chicken/barcode=001234982828) and this query is then forwarded to all agents who have registered that they have some related knowledge. Information is returned by these agents and collated into a data structure (for example, a data tree) which is returned to the client.

This classification system provides a means by which a structured information space can be used to get the different agents using the same “language” in order that the question or fact for which information is required is understood.

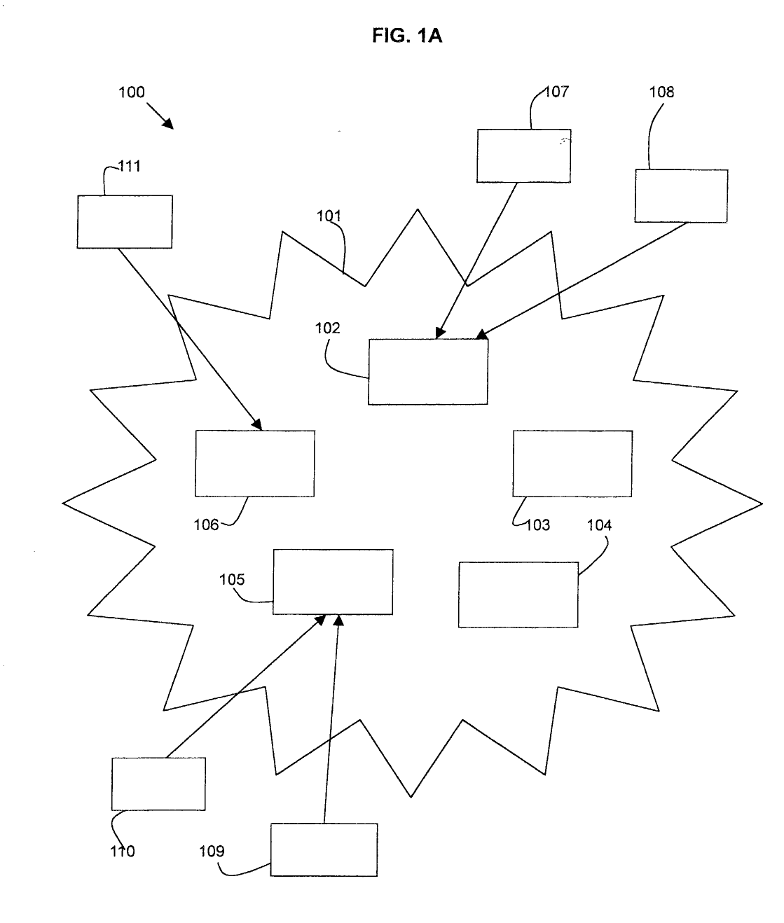

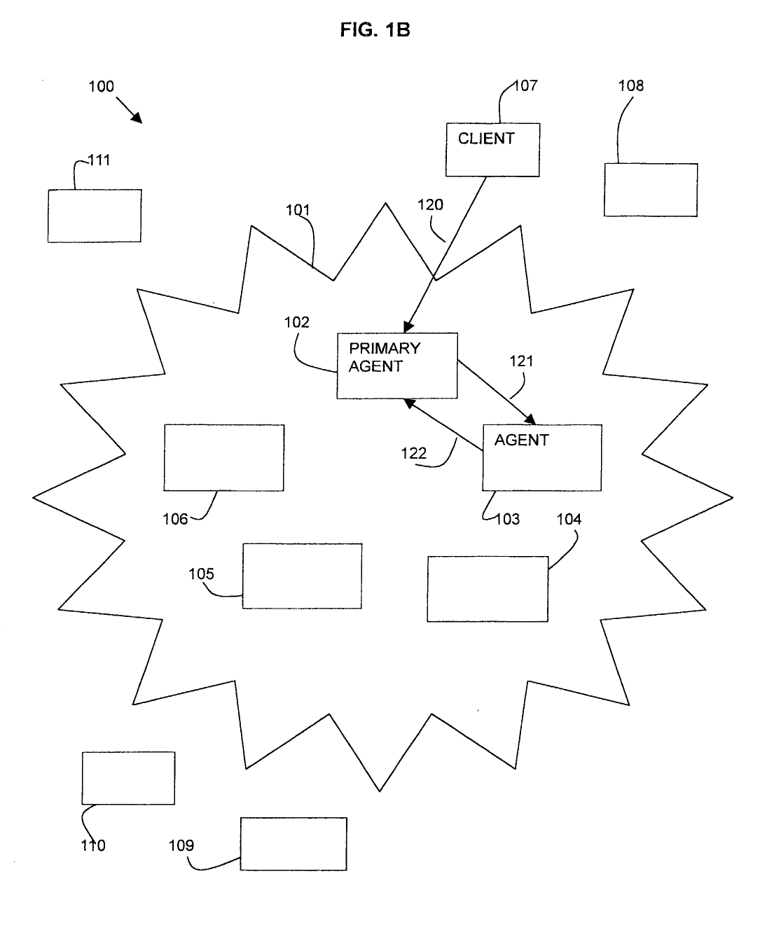

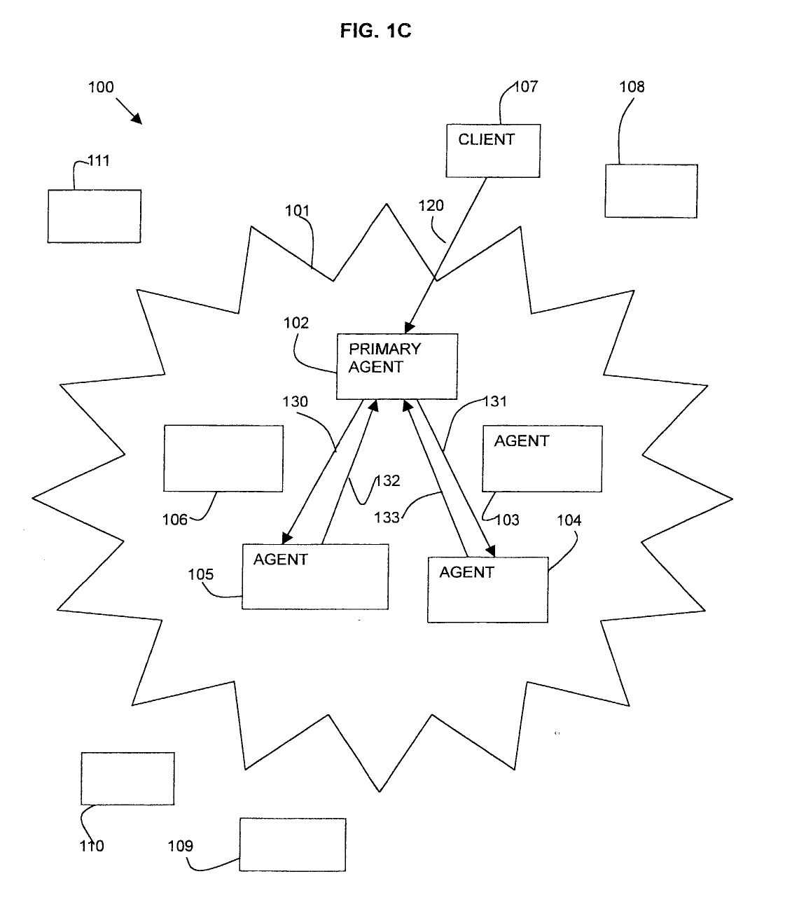

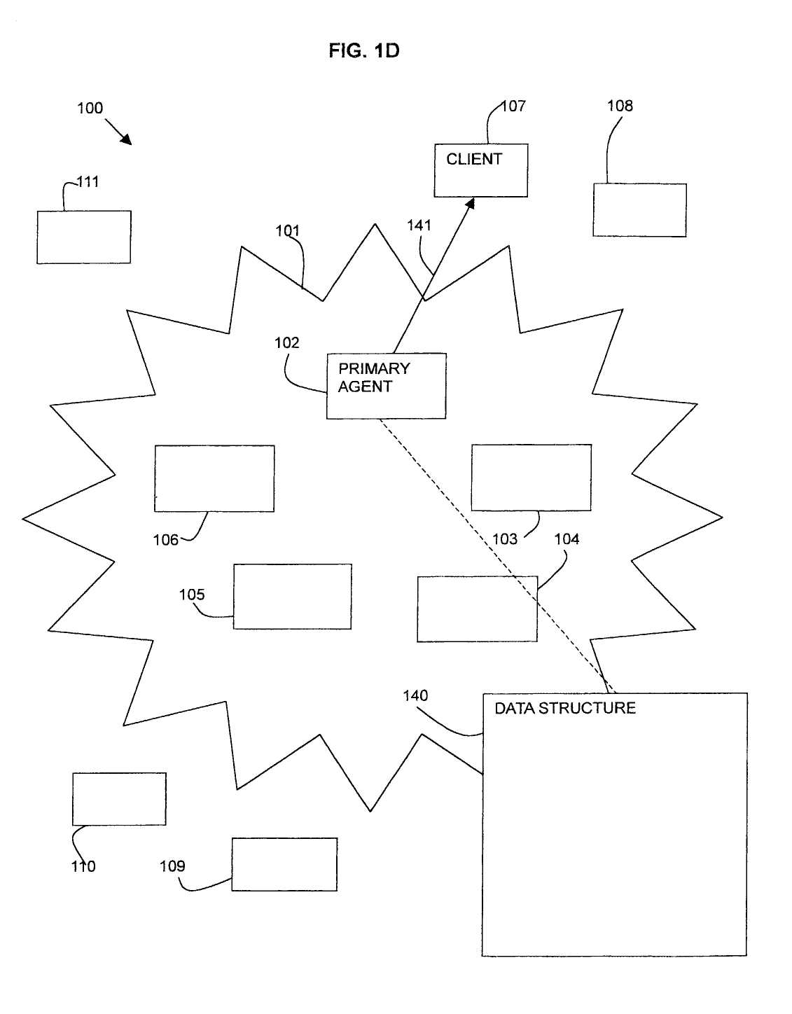

FIG. 1A shows a system 100 with a network 101 in which there are a plurality of agents 102, 103, 104, 105, 106. The possible forms of the agents is discussed in detail below.

The agents 102, 103, 104, 105, 106 all use a common information classification system. For example, the agents may all use a hierarchical topic classification system, or the agents may all use a XML based system.

Clients 107, 108, 109, 110, 111 communicate with an agent in the network 101. For example, client 107 communicates with agent 102. The clients use the same common information classification system when requesting information from the agents.

One of the agents 102 is designated as the primary agent. The primary agent 102 handles an enquiry from a client, for example client 107. The primary agent 102 has a registry function which enables it to know the capabilities of the other agents 103, 104, 105, 106. the primary agent 102 holds a map of the other agents and the parts of the information space about which each agent has knowledge.

The agents 102, 103, 104, 105, 106 may each have knowledge of each other's capabilities or only designated agents may have the registry function.

In FIG. 1B, client 107 sends a request 120 to agent 102 which then acts as the primary agent for this request. The request 120 is for information relating to “food/curry/chicken/barcode=001234982828”.

The primary agent 102 knows from its map of the information space that agent 103 is registered as specialising in information relating to barcodes. Therefore, the primary agent 107 forwards the request 121 to agent 103. Agent 103 holds the information that barcode=001234982828 is for the dish chicken vindaloo curry. This information is returned 122 to the primary agent.

The primary agent 102 could simply return this information to the client 107.

However, as data is returned, this may be used to feed subsequent requests back into the infrastructure in order to expand the data structure. Thus the search is an iterative process.

As well as explicit topics, wildcards may be used to find topics whose topic string may not be known. For example, the topic “food/*/barcode” could be used.

As shown in FIG. 1C, the primary agent 102 may feed back the topic string “food/curry/chicken/vindaloo” as a query to all agents who are registered as holding information relating to this topic string.

For example, agent 104 specialises in information relating to food allergies and agent 105 specialises in food ingredients. Therefore, requests 131, 130 for information are sent to agents 104, 105 by the primary agent 102 and responses 132, 133 are received.

In FIG. 1D, from the responses 122, 132, 133 received at the primary agent 102, the primary agent compiles a data structure 140 and sends 141 the data structure 140 to the client 107. The client 107 can then browse the data structure which provides details of the information available and the client 107 can select the information of interest.

In the example, as a barcode is submitted it is possible only a barcode decoding agent is able to respond with details of the barcode. Once this has been returned this may be fed back into the infrastructure and agents who know about chicken or food ingredients or chicken allergies may all be able to respond.

The data structure is thus expanded through this iterative search process. Unlike a common search engine, multiple branches of the tree may be being followed in parallel. Rather than honing the information, the information is being expanded and added to but is tightly classified according to the common system such that it is easy to view.

Weights may be added to the data structure such that branches are culled at a certain point (i.e. do not expand indefinitely). This may happen, for example, if the information being returned is very out of date or the provenance is suspect.

When assembling the data structure, the primary agent might add weighting information that indicates the relevance of a particular branch. This weighting would enable branches to be culled at a certain point thereby preventing further time consuming expansion. Other information might be acquired from the data source, relating to the age of the data and to other aspects of its provenance. This information could be incorporated in the weighting.

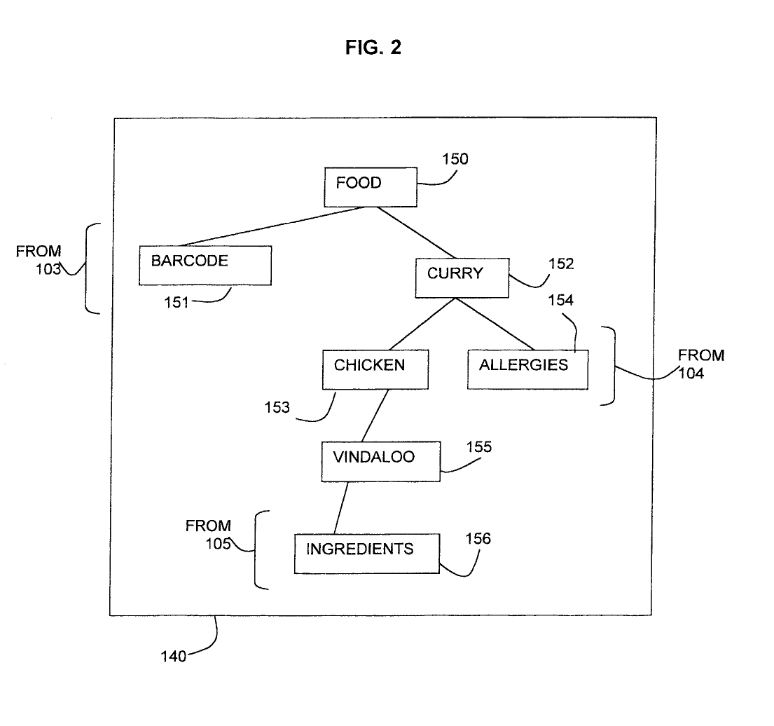

FIG. 2 shows a data structure 140 that may be generated by the process of FIGS. 1A to 1D. The data structure 140 is in the form of a tree hierarchy with branches provided by the information from the different agents.

The root 150 of the tree is “food”. A branch 151 from the root 150 is information relating to “barcode” as derived from agent 103. Another branch 152 from the root 150 relates to “curry” and has child nodes for “chicken” 153 and “allergies” 154. The information relating to “food/curry/allergies” is provided by agent 104. The “chicken” node 153 has a child node for “vindaloo” 155 which in turn has a child node 156 for “ingredients”. The information relating to “food/curry/chicken/vindaloo/ingredients” is provided by agent 105.

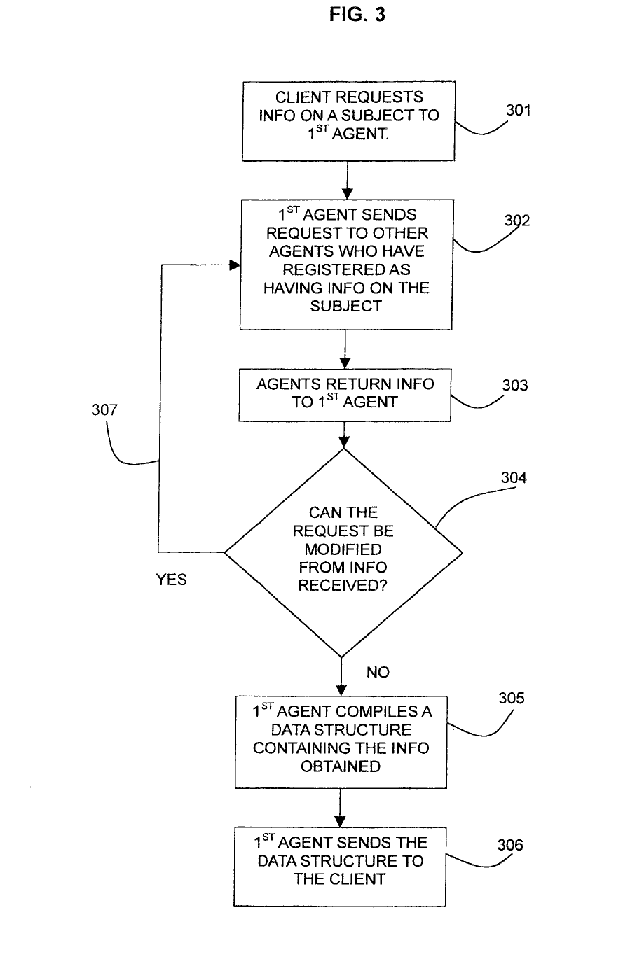

FIG. 3 shows a flow diagram of the described method. At step 301, the client requests information on a subject and sends the request to a primary agent. At step 302, the primary agent sends the request to other agents who have registered as having information on the subject. The agents return the information to the primary agent at step 303.

It is then determined at step 304 by the primary agent whether the request could be modified from the information received. If the request could be modified the loop 307 is used to feed the modified request back to agents who have registered as having information on the subject of the modified request. If the request cannot be modified, step 305 is undertaken and the primary agent compiles a data structure containing the information obtained from the various agents. At step 306, the primary agent sends the data structure to the client.

A common classification system is preferably used by the agents and the client requesting information. In the above example, a hierarchical classification in the form of a topic path is used with a tree data structure. Such a common classification system is not however essential, as long as it is possible to translate received information to a format that can be understood by the receiver.

As an alternative embodiment, the common classification system could use XML (extensible Markup Language). XML provides a means for creation of customised tags that offer flexibility in organizing and presenting information. XML gives a richer description of the information hierarchy than is provided by a simple topic path.

The classification used previously could be represented in XML as:

<food>

<curry>

<chicken>

<vindaloo>
</vindaloo>

</chicken>

</curry>

</food>

In this instance, the lowest level can be simplified to a single line: <vindaloo/>, i.e.

<food>

<curry>

<chicken>

<vindaloo/>

</chicken>

</curry>

</food>

The richness of the description of the information hierarchy comes from the addition of attributes, for example, <curry base=“meat”> and <curry base=“vegetable”>. This can be exploited to condense the hierarchy, for example, <curry meat=“chicken” strength=“very hot”>.

In a first specific embodiment, a publish/subscribe message broker is used for its basic messaging infrastructure, using topic-based publications and subscriptions. This technology will be well known to someone skilled in the art.

An example of a messaging infrastructure is WebSphere MQ Integrator provided by International Business Machines Corporation (WebSphere is a trade mark of International Business Machines Corporation).

Conventional message brokers in a messaging infrastructure provide hubs for processing, transformation and distribution of messages. Message brokers act as a way station for messages passing between applications. Once messages have reached the message broker they can proceed, depending on the configuration of the message broker and on the contents of the message.

Topics provide the key to the delivery of messages between publishers and subscribers. They provide an anonymous alternative to citing specific destination addresses. The broker attempts to match the topic in each published message with a list of clients who have subscribed to that topic.

In the publish/subscribe model, applications known as publishers send messages and others, known as subscribers, receive messages. Applications can also be both publishers and subscribers. The publishers are not interested in where their publications are going, and the subscribers need not be concerned where the messages they receive have come from. The broker assures the validity of the message source, and manages the distribution of the message according to the valid subscriptions registered in the broker.

The interactions between a broker and its publisher and subscriber applications are equally valid in a broker network in which publish/subscribe applications are interacting with any one of a number of connected brokers. Subscriptions and published messages are propagated through the broker domain. Brokers can propagate subscription registrations through the network of connected brokers, and publications can be forwarded to all brokers that have matching subscriptions. When the term “broker” is used it generally includes a single broker or multiple brokers working together as a network to act as a single logical broker.

A single publish/subscribe broker might not have the capacity to carry out the proposed information enrichment method alone:

It can not maintain a sufficient index to all the information available, partly for reasons of storage capacity, but principally owing to the impossibility of predicting the topics arriving as published requests;

The varying and unpredictable workload will sometimes outreach the capacity of the broker.

In short, performing the enrichment process within a single publish/subscribe broker does not offer a scalable solution. It is therefore necessary to delegate the tasks of: searching the information space; collating the results; and formulating the response message(s). For this purpose, a network of agents in the form of publish/subscribe message brokers does offer a scalable solution.

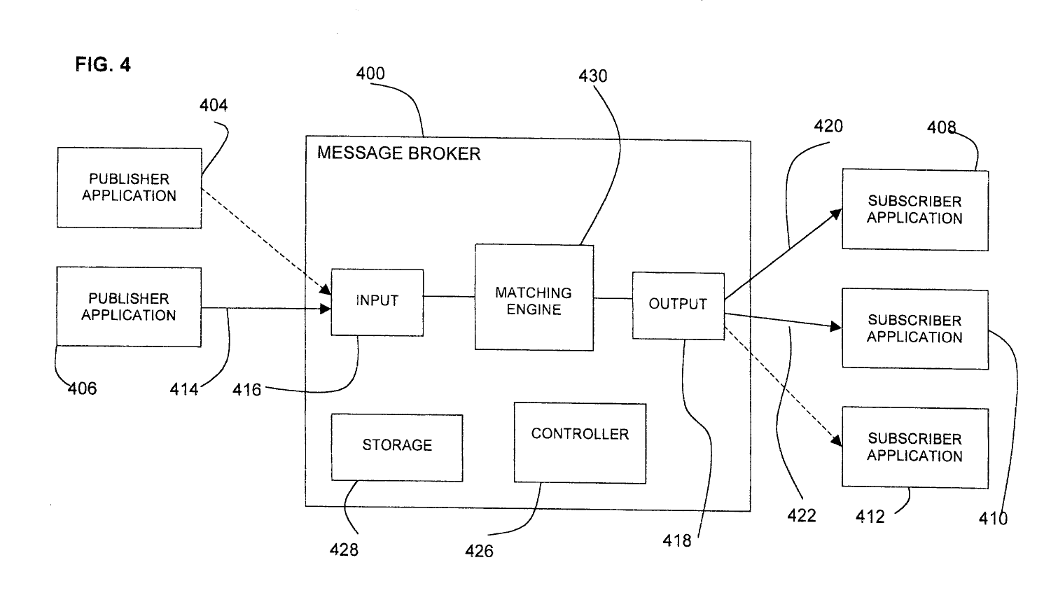

Referring to FIG. 4, a single message broker 400 known from the prior art is shown with two publisher applications 404, 406 and three subscriber applications 408, 410, 412. The publisher and subscriber applications may be computer programs within a network of computer systems or may be in a single computer.

In the illustrated example, two publisher applications 404, 406 and three subscriber applications 408, 410, 412 are shown; however, it will be appreciated by a person skilled in the art that this is an example only and an infinite number of arrangements of applications and brokers is possible and only a very simple example is shown.

The message broker 400 has a controller 426 for processing messages and storage means 428 for storing messages in transit. The message broker 400 has an input mechanism 416 which may be an input queue or a synchronous input node by which messages are input when they are sent by a publisher application 404, 406 to the message broker 400. The message broker 400 has a matching engine 430, which compares the topic of the message with the registered subscriptions of the various subscriber applications, and from the result of that matching derives a recipient list. The message broker 400 has an output mechanism 418 by which messages are output once they have been processed by the message broker 400 and are transmitted to the subscriber applications that are specified in the recipient list.

A message sent by a publisher application 406 is transmitted 414 to the message broker 400 and is received by the message broker 400 into the input mechanism 416. The message is fetched from the input mechanism 416 by the controller 426 of the message broker 400 and processed to determine to which subscriber applications 408, 410, 412 the message should be sent and whether the message should to transformed or interrogated before sending. Once processed, the message is sent to an output mechanism 418 for sending. There may be more than one input and output mechanism to and from which messages are received and sent by the message broker 400.

In the illustrated example in FIG. 4, a message is transmitted 414 from a single publisher application 406 to the input mechanism 416 of the message broker 400. The message is processed in the message broker 400 by a matching engine 430 and put into the output mechanism 418 for sending to two subscriber applications 408, 410 by transfers 420, 422.

A conventional message broker as illustrated in FIG. 4 can be used as an agent as part of the described information enrichment method and system.

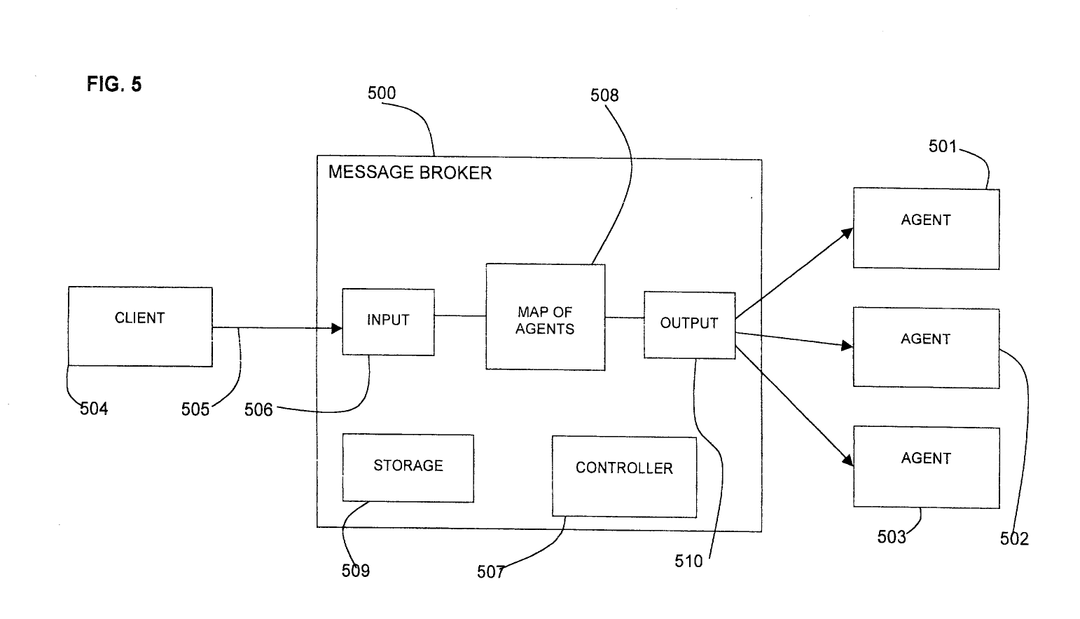

Referring to FIG. 5, a message broker 500 acting as a primary agent is shown. A plurality of other agents 501, 502, 503 which may be other message brokers are registered with the message broker 500 as subscribers. The subscription of each agent 501, 502, 503 provides details of the classes of request for which the agent can provide information.

A client application 504 publishes a request 505 to the message broker 500. The message broker 500 receives the request 505 in the input queue 506 and the controller 507 of the message broker 500 uses a map 508 of the registered agents and their capabilities to match the published request 505 to the relevant subscribers in the form of the agents 501, 502, 503 via an output queue 510. The message broker 500 also has storage means 509 for storing returned information from the agents 501, 502, 503 before responding to the client application 504.

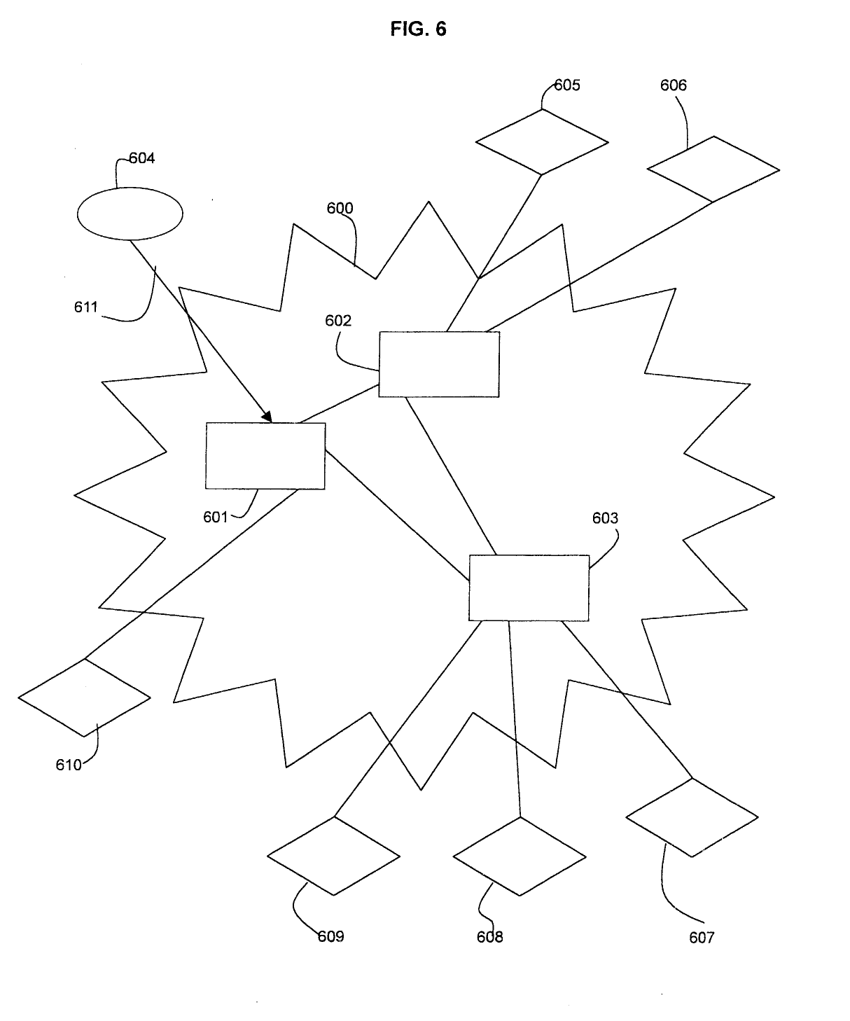

In FIG. 6 a network 600 of hubs is shown. The illustrated network 600 includes three hubs 601, 602, 603. The hubs 601, 602, 603 are in the form of message brokers each having one or more agents in the form of data resources. The first hub 601 has a single agent 610. The second hub 602 has two agents 605, 606 and the third hub 603 has three agents 607, 608, 609.

A client 604 sends a query 611 to one of the hubs 601 which becomes the primary agent for the query 611. The hub 601 which is a message broker handles the query 611 as previously described in relation to FIG. 5 and sends the query to any of the other hubs 602, 603 which are registered as having agents which can provide data relating to the class of the query.

The network comprises a number of interconnected hubs, which have knowledge of each other's capabilities. This is sometimes described as forward knowledge, in that it enables one hub to forward a query (which the first hub cannot itself handle) to another hub, knowing in advance that the second hub has the ability to process that query. Individual software agents each register their capabilities with one or more of the hubs, such that the latter hold a map of those parts of the information space about which they have knowledge.

A query—a request for additional information—may identify two aspects of the information space as being of interest. The publish/subscribe broker submits this query initially to one hub. This first hub can deal with one of the aspects itself but not the other, so it routes a sub-query to a second hub.

Meanwhile, the first hub also notifies those agents which have registered the requisite capability and collates the returned information as it arrives back from those agents. When the additional information is routed back from the second hub, that too is collated.

In passing, it is envisaged that the act of collation corresponds to the merging of two or more XML trees. For example,

<food><curry strength=“very hot”><chicken/></curry></food>

plus

<food><curry><poppadom/></curry></food>

yields

<food><curry strength=“very hot”><poppadom/></curry></food>

When all the agents have reported back, with or without new information, the first hub can return the assembled information to the publish/subscribe broker.

If a broker implementation is used, the primary—or first—hub would usually be an independent broker, but the possibility of using the original publish/subscribe broker is not excluded, always provided that it can contain the workload. The agents, however, will always operate independently; however, it is possible that one or more agents reside on the same physical machine as the broker.

The described method may be implemented in a number of ways, publish/subscribe broker technology being one, and TSpaces being another example. TSpaces is a Java™ based intelligent communication intermediary developed by International Business Machines Corporation that combines a database with a tuple space (Java is a trademark of Sun Microsystems Inc. in the United States and/or other countries). The function is to receive, deliver, and broker communications and services, enabling collaboration among network elements (users, devices, software programs and web sites). It will be evident to a person skilled in the art how the above described method could be used in the context of TSpaces.

Other forms of implementation as well as publish/subscribe broker systems and TSpaces are also envisaged, for example peer-to-peer networks.

This is a scalable solution, because the full range of information-seeking capacity can be distributed across a number of hubs and agents. Both the range and the number are extensible.

The described process is now illustrated with an example which requires just a single hub, but one which has a variety of agents registered with it.

### EXAMPLE

The mechanism proceeds as follows: the person or entity that wishes to find out more about a particular item publishes a request to a publish/subscribe system (set up specifically for this purpose), using a topic name which includes the classification of the item, and includes the unique identifier. Topic names are assumed to be arranged hierarchically (like a URI), and match the components of the information hierarchy in which it is being classified. The body of the message would be something to indicate that this is a request being submitted, so contain the word “query”, for example.

So, for example if the barcode on a frozen meal is read by a user, about which further information is required, the user might publish a message to topic: “food/meals/frozen/chicken/curry/001234982828”, where everything up to the final component (delimited by slashes) is the position within the information hierarchy, and the final leaf element is the barcode. Note that the identifiers do not have to be globally unique—only strictly within the path implied by the rest of the topic name (“food/meals/frozen/chicken/curry”). Although in practice, the scope of identifiers is likely to be much broader. XML might be used to give a richer description of the information hierarchy than is provided by a simple topic path.

Elsewhere on the network, there are software agents, which are subscribers to the same publish/subscribe messaging system as the request was submitted to. They have specific knowledge (or have access to specific knowledge) about various things, and they advertise their area of specialisation by subscribing to appropriate topics in the pub/sub information space. So for example, an agent specialising in food ingredients of products might subscribe to “food/*”, in order to receive any requests to do with food. An agent specialising in chicken dishes might subscribe to “food/*/chicken/*” in order to catch any chicken-orientated requests. Of course any given agent will most likely subscribe to a large set of topics, devised to ensure good coverage of its areas of specialist knowledge.

Some agents may have knowledge which they can apply to non-specific domains. A good example is an agent specialising in the selection of an appropriate type of music to accompany a certain meal. In this case, the subscription would probably be to a broad category, like “food”, and the agent would in some way make use of the relevant information contained in the rest of the topic name that was used, to determine which kind of music was appropriate for that kind of food. The results in this case could be highly subjective.

At this point the notion of “hard” facts and “soft” facts is introduced. “Hard” facts are used to describe those things which are factual and largely indisputable about an item, e.g. ingredients, cooking instructions, etc. “Soft” facts are things which are subjective, often derived from data mining based on statistics gathered from other examples. Examples would be music to accompany a particular meal, or other books a person might consider reading if they enjoyed this one, etc.

When the agents receive “query” type messages on any of the topics to which they are described, they use the information contained in the topic name (particularly if they had subscribed to a broad topic family: much of the essential information for them to perform their function will be contained in the specific topic name of the query). If they find that they have some information to contribute about the item in question, either “hard” or “soft” facts, they construct a message containing the information, along with other meta data to identify what sort of information this is—what categories of the information hierarchy it is responding to, etc. XML would be an ideal way to encode such information, as then a common schema could be adhered to. The message is then published to a topic which starts with the topic on which the original query was sent, with “/hard”, or “/soft” appended to the end, depending on whether it is a hard or a soft fact.

The reason for doing this, is that the entity which submitted the original request might not be interested in subjective information about their item, only in objective information. The entity subscribes to a topic which is essentially the “listener” for responses to their request, so it might be: “food/meals/frozen/chicken/curry/001234982828/*”, or could be “food/meals/frozen/chicken/curry/001234982828/hard”, if they only wanted “hard” facts.

Of course various agents and requesters will receive various “spurious” messages by this mechanism of subscription, especially where extensive use of wild-carding is made—it will be likely that a user will receive his own messages from time to time, but it will be easy to filter these out by reference to the nature of the content of the message, and a record of submitted requests awaiting responses.

The examples of the specific embodiments are examples only and should not be construed to limit the scope of the present invention. The invention is not limited to brokering systems and models that do not include brokers could equally be used. For example, peer-to-peer networks.

Advantageously the agents or hubs can be loosely coupled. Apart from any registration protocol, it is not important how the agents work.

Information can be scaled as the described invention can preferably cope with narrow or broad ranges of topics. In addition, the load can be scaled as the work can be distributed over more agents or hubs.

Improvements and modifications can be made to the foregoing without departing from the scope of the present invention.

What is claimed is:

1. A method for information enrichment in a system having a plurality of sources (102, 103, 104, 105, 106) of information, the method comprising:
each source (102, 103, 104, 105, 106) registering as being capable of providing information in respect of at least one specific class of request;
receiving a request for information (120);
distributing the request (120) to one or more sources (103, 104, 105, 106) that are registered for that class of request.

2. A method as claimed in claim 1, comprising:
processing a response from at least one source; and
sending an amended request (130, 131) to one or more sources (104, 105).

3. A method as claimed in claim 1, wherein one of the sources (102) has a registry function which registers the capabilities of the other sources (103, 104, 105, 106).

4. A method as claimed in claim 1, wherein each source (102, 103, 104, 105, 106) registers with all the other sources.

5. A method as claimed in claim 1, wherein the method includes the request (120) being received at a primary source (102) and responses (122, 132, 133) from other sources being returned to the primary source (102).

6. A method as claimed in claim 1 comprising compiling responses (122, 132, 133) from sources (102, 103, 104, 105, 106) in data structure (140).

7. A method as claimed in claim 6, wherein the data structure is returned to the origin of the request (107).

8. A method as claimed in claim 1, wherein the request (120) for information and/or the responses (122, 132, 133) from sources indicate if the data is factual or subjective.

9. A method as claimed in claim 1, wherein the plurality of sources (102, 103, 104, 105, 106) includes publish/subscribe messaging brokers (601, 602, 603).

10. A method as claimed in claim 9, wherein the plurality of sources (102, 103, 104, 105, 106) register their capabilities by means of subscribing to other messaging brokers (601, 602, 603).

11. A method as claimed in claim 1, wherein the sources (102, 103, 104, 105, 106) have peer to peer relationships.

12. A method as claimed in claim 1, wherein the plurality of sources (102, 103, 104, 105, 106) uses TSpaces services.

13. A method as claimed in claim 1, wherein each source uses a common information classification system, each source being registered as being capable of providing information in respect of at least one specific class in the common information classification system and the received request for information using the common information classification system.

14. A method as claimed in claim 1, wherein each source uses a common information classification system, each source being registered as being capable of providing information in respect of at least one specific class in the common information classification system and the received request for information using the common information classification system, the common information classification system using topic hierarchies.

15. A method as claimed in claim 1, wherein each source uses a common information classification system, each source being registered as being capable of providing information in respect of at least one specific class in the common information classification system and the received request for information using the common information classification system, the common information classification system using XML.

16. A method as claimed in claim 1, the step of distributing the request to one or more sources is responsive to the step of translating, for each source, the request to a format compatible with that source.

17. A method as claimed in claim 1, comprising the step of:
receiving a response from one or more sources, wherein at least one response is not in a common format used for collating any received responses; and
translating said response to the common format.

18. A system for information enrichment comprising:
a plurality of sources (102, 103, 104, 105, 106) of information;
each source (102, 103, 104, 105, 106) being registered as being capable of providing information in respect of at least one specific class of request;
a client application (107);
wherein a request for information (120) from the client application (107) is distributed to sources registered for that class of request.

19. A system as claimed in claim 18 comprising:
means for processing a response from at least one source (103); and
means for sending an amended request (130, 131) to one or more sources (104, 105).

20. A system as claimed in claim 18, wherein one of the sources (102) has a registry function which registers the capabilities of the other sources (103, 104, 105, 106).

21. A system as claimed in claim 18, wherein each source (102, 103, 104, 105, 106) is registered with the other sources (102, 103, 104, 105, 106).

22. A system as claimed in claim 18, comprising means for compiling responses (122, 132, 133) from sources (102, 103, 104, 105, 106) in a data structure (140).

23. A system as claimed in claim 22 comprising means for returning (141) the data structure to the origin of the request (107).

24. A system as claimed in claim 18, wherein the plurality of sources (102, 103, 104, 105, 106) includes publish/subscribe messaging brokers (601, 602, 603).

25. A system as claimed in claim 24, wherein the plurality of sources (102, 103, 104, 105, 106) register their capabilities by means of subscribing to other messaging brokers (601, 602, 603).

26. A system as claimed in claim 18, wherein the sources (102, 103, 104, 105, 106) have peer to peer relationships.

27. A system as claimed in claim 18, wherein the plurality of sources (102, 103, 104, 105, 106) uses TSpaces services.

28. A system as claimed in claim 18, wherein each source uses a common information classification system, each source being registered as being capable of providing information in respect of at least one specific class in the common information classification system, the client application using the common information classification system.

29. A system as claimed in claim 18, wherein each source uses a common information classification system, each source being registered as being capable of providing information in respect of at least one specific class in the common information classification system and the received request for information using the common information classification system, the common information classification system using topic hierarchies.

30. A system as claimed in claim 18, wherein each source uses a common information classification system, each source being registered as being capable of providing information in respect of at least one specific class in the common information classification system and the received request for information using the common information classification system, the common information classification system using XML.

31. A system as claimed in claim 18, wherein the request (120) is received at a primary source (102) and responses (122, 132, 133) from other sources are returned to the primary source (102).

32. A system as claimed in claim 18, wherein the request (120) for information and/or responses (122, 132, 133) from sources indicate if the data is factual or subjective.

33. A system as claimed in claim 18, wherein means for distributing the request to sources registered for that class of request is responsive to means for translating, for each source, the request to a format compatible with that source.

34. A system as claimed in claim 18, comprising:
means for receiving a response from one or more sources, wherein at least one response is not in a common format used for collating any received responses; and
means for translating said response to the common format.

35. A computer program product stored on a computer readable storage medium for use in a system having a plurality of sources (102, 103, 104, 105, 106) of information, comprising computer readable program code means for performing the steps of:
each source (102, 103, 104, 105, 106) registering as being capable of providing information in respect of at least one specific class of request;
receiving a request for information (120) at one of the sources (102, 103, 104, 105, 106);
distributing the request to one or more other sources that are registered for that class of request.

36. A method for information enrichment in a system having a plurality of sources (102, 103, 104, 105, 106), each source (102, 103, 104, 105, 106) registered as being capable of providing information in respect of at least one specific class of request, the method comprising:
receiving a request for information (120); and
distributing the request (120) to one or more sources (103, 104, 105, 106) that are registered for that class of request.

37. A method as claimed in claim 36, comprising the steps of:
receiving a response from at least one source;
processing the response; and
sending an amended request (130, 131) to one or more sources (104, 105).

38. A method as claimed in claim 36, comprising the step of:
compiling responses (122, 132, 133) from sources (102, 103, 104, 105, 106 in a data structure (140).

39. A method as claimed in claim 38 comprising the step of returning the data structure to the origin of the request (107).

40. A method as claimed in claim 36, wherein the plurality of sources (102, 103, 104, 105, 106) includes publish/subscribe messaging brokers (601, 602, 603).

41. A method as claimed in claim 36, wherein each source uses a common information classification system, each source being registered as being capable of providing information in respect of at least one specific class of request in the common information classification system and the received request for information using the common information classification system.

42. A method as claimed in claim 41 wherein the common information classification system uses topic hierarchies.

43. A method as claimed in claim 41 wherein the common information classification system uses XML.

44. A method as claimed in claim 36, the step of distributing the request to one or more other sources is responsive to the step of translating, for each source, the request to a format compatible with that source.

45. A method as claimed in claim 36, comprising the step of:
receiving a response from one or more sources, wherein at least one response is not in a common format used for collating any received responses; and
translating said response to the common format.

46. Apparatus for information enrichment in a system having a plurality of sources (102, 103, 104, 105, 106), each source (102, 103, 104, 105, 106) registered as being capable of providing information in respect of at least one specific classes of request, the apparatus comprising:
means for receiving a request for information (120); and
means for distributing the request (120) to one or more sources (103, 104, 105, 106) that are registered for that class of request.

47. Apparatus as claimed in claim 46, comprising:
means for receiving a response from at least one source;
means for processing the response; and
means for sending an amended request (130, 131) to one or more sources (104, 105).

48. Apparatus as claimed in claim 46, comprising means for compiling responses (122, 132, 133) from sources (102, 103, 104, 105, 106 in a data structure (140).

49. Apparatus as claimed in claim 48 comprising means for returning the data structure to the origin of the request (107).

50. Apparatus as claimed in claim 46, wherein the plurality of sources (102, 103, 104, 105, 106) includes publish/subscribe messaging brokers (601, 602, 603).

51. Apparatus as claimed in claim 46, wherein each source uses a common information classification system, each source being registered as being capable of providing information in respect of at least one specific class of request in the common information classification system and the received request for information using the common information classification system.

52. Apparatus as claimed in claim 51 wherein the common information classification system uses topic hierarchies.

53. Apparatus as claimed in claim 51 wherein the common information classification system uses XML.

54. Apparatus as claimed in claim 46, wherein the means for distributing the request to one or more other sources is responsive to means for translating, for each source, the request to a format compatible with that source.

55. Apparatus as claimed in claim 46, comprising:
means for receiving a response from one or more sources, wherein at least one response is not in a common format used for collating any received responses; and
means for translating said response to the common format.

56. A computer program product stored on a computer readable storage medium for use in a system having a plurality of sources (102, 103, 104, 105, 106) of information, comprising computer readable program code means for performing the steps of:
receiving a request for information (120); and
distributing the request (120) to one or more sources (103, 104, 105, 106) that are registered for that class of request.

57. A source of information for participating in information enrichment, the source comprising:
means for registering with a server as being capable of providing information in respect of at least one specific class of request;
means for receiving a request for information (120) in respect of one of any registered classes; and
means for responding to said request.

58. A method for participating in information enrichment comprising the steps of:
registering with a server as being capable of providing information in respect of at least one specific class of request;
receiving a request for information (120) in respect of a specific class of request; and
responding to said request.

59. A computer program product stored on a computer readable storage medium, the computer readable program code means for performing the steps of:
registering with a server as being capable of providing information in respect of at least one specific class of request;
receiving a request for information (120) in respect of a specific class of request; and
responding to said request.
